(19) United States
(12) Patent Application Publication
(10) Pub. No.: US 2005/0262036 A1
(43) Pub. Date: Nov. 24, 2005

(54) Navigating to data in source system

(76) Inventors: Martin Diewald, Walldorf (DE); Markus Kupke, Dielheim (DE); Jens Weidner, Leimen (DE); Marcus Dill, Wiesloch (DE)

Correspondence Address: FISH & RICHARDSON, P.C., PO BOX 1022, MINNEAPOLIS, MN, 55440-1022, US

(21) Appl. No.: 10/842,247

(22) Filed: May 10, 2004

(51) Int. Cl. G06F 7/00

(52) U.S. Cl. 707/1

(57) ABSTRACT

Systems and techniques for providing user navigation to electronic data stored in a data source system. A method may include obtaining, in a data repository management system, pre-selected electronic data stored in a data source system, and providing an output for displaying the pre-selected electronic data on an access device. The output creates a navigation link that upon user selection prompts the data repository management system for navigation target information for accessing the pre-selected electronic data stored in the data source system. A user input using the navigation link may be received at the data repository management system, indicating a request for access to the pre-selected electronic data in the data source system. In response, the data repository management system provides information to the access device, causing it to guide user navigation to access the pre-selected electronic data stored in the data source system.

### TECHNICAL FIELD

This description relates to navigating from displayed data to data in a source system from which the displayed data was obtained.

### BACKGROUND

Many computer systems include components that can be characterized as a backend and frontend, respectively. Typically, the backend processes and stores data, among other functions, and the frontend is responsible for presenting the backend data and allowing users to manipulate it when applicable. For example, the R/3 system from SAP AG in Walldorf, Germany is a backend system that is capable of handling many different types of data processing and management in an enterprise resource planning (ERP) environment, such as operations related to customer relationship management (CRM), to name just one example. Moreover, SAP provides a Business Warehouse (BW server) system that offers data repository management functions that can be used in connection with the backend. For example, the BW server lets users formulate queries that can be run on various data repositories of backend data. The BW server also provides visual displays for presenting query results in formats that are most suitable for the various users of the system. These visual displays that present operational data to a user may be referred to as reports, because they are akin to a traditional paper-based business report.

One disadvantage with the mentioned existing systems and other systems is that the report displayed to the user has no useful connection to the operational data in the backend. That is, when the user sees something in a report that prompts the user to go look up the source for the report data, these systems do not provide a convenient user navigation to the source data. For example, when the user is looking at a particular table in a report generated by a data repository management program, there is no convenient way for the user to navigate to the backend source data that was used in creating the table. Rather, the user typically must identify the proper backend application program that handles the sought operational data, and access the backend system to launch that application program. Moreover, it may be necessary for the user to know a specific object key to access the data in the backend system.

### SUMMARY

The invention relates to navigating to data in a source system.

In a first general aspect, a method of providing user navigation to electronic data stored in a data source system comprises providing, from a data repository management system and to an access device, an output that causes a visual display of pre-selected electronic data on the access device. The pre-selected electronic data has been obtained by the data repository management system from a data source system. There is received, at the data repository management system and from the access device, a user input indicating a request for access to the pre-selected electronic data in the data source system. In response to receiving the user input, there is provided, to the access device, information causing the access device to guide user navigation to access the pre-selected electronic data stored in the data source system.

In selected embodiments, the pre-selected electronic data is associated with a first key in the data source system and with a second key in the data repository management system. The user input may include the second key, and the second key may be used in determining the first key in the data repository management system for providing the information. The data repository management system may include a table that can be used for determining the first key. The pre-selected electronic data may be included in an object and determining the first key may comprise accessing an attribute of the object where the first key is stored.

In a second general aspect, a method of providing user navigation to electronic data stored in a data source system comprises obtaining, in a data repository management system, pre-selected electronic data stored in a data source system. An output is provided to an access device to cause a visual display of the pre-selected electronic data on the access device. The output further creates on the access device a navigation link that upon user selection prompts the data repository management system for navigation target information for accessing the pre-selected electronic data stored in the data source system.

Advantages of the systems and techniques described herein may include any or all of the following. Providing user navigation from displayed data to a data source where the displayed data was obtained. More efficient navigation to operational data. Providing convenient mapping between different object keys in different systems that relate to the same data. Improved data repository management. Improved context menu for use with displayed data. An improved data repository management system. A more user-friendly graphical user interface.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a system wherein a user can navigate to data in a source system;

FIGS. 2A and 2B are flow charts of embodiments of inventive methods;

FIG. 3 is another block diagram with examples of features in the system shown in FIG. 1;

FIG. 4 is a sequence diagram of an exemplary operation performed in the system shown in FIG. 3; and

FIG. 5 is a block diagram of a general computer system.

Like reference numerals in the various drawings indicate like elements.

### DETAILED DESCRIPTION

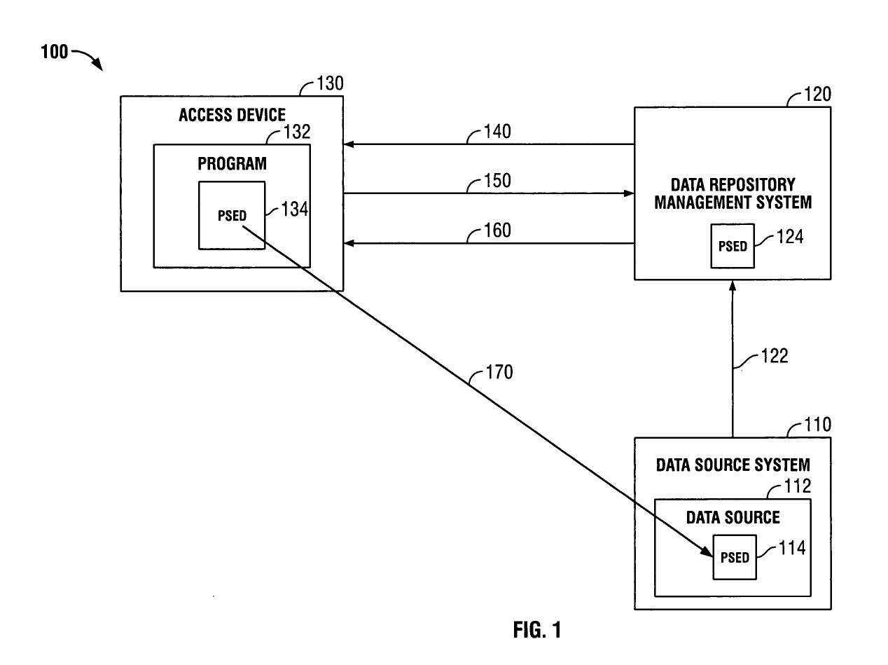

FIG. 1 shows an example of a system 100 that provides user navigation to operational data. The system 100 includes a data source system (DSS) 110, such as a backend system. The DSS may include one or more data sources 112, such as application programs that process and store operational data. Typically, the data source 112 will handle large volumes of data, divided in larger or smaller units, such as data objects. For clarity, however, the data source 112 here is shown including only a single data unit, a pre-selected electronic data (PSED) 114.

The PSED can be any of a great variety of source data. For example, the PSED may correspond to a marketing campaign that is planned in the DSS (or an element of such a campaign). As another example, the PSED may be a customer record for a customer of the organization using the DSS. As yet another example, the PSED can be the “revenue” of a business operation that the DSS handles.

From time to time, such as at regularly scheduled intervals, data in the DSS may be replicated to a data repository management system (DRMS) 120, as schematically indicated by an arrow 122. One purpose of the replication may be to make data available to the DRMS such that users can run queries on it. For example, the DRMS may use the replicated data in generating reports. In this exemplary system, the replication results in the DRMS storing a PSED 124 that is based on the PSED 114 stored in the DSS. The PSED 124 is available to the DRMS for use in responding to data repository queries and in generating reports, for example.

Here, the DRMS will use the PSED 124 to generate a report. This may involve formatting the data in a way that fits the user's need for information. When the DRMS generates a report based on a multi-dimensional data table, for example, the resulting report may display only selected portions or aspects of that data (i.e., selected dimensions) at a time. For example, sales figures can be tabulated by customer, by fiscal year, or by sales region. These various configurations of the same complex body of data may be referred to as “drilidowns” on the data, because they allow the user to drill down on a particular aspect of data that that user is most interested in. Accordingly, the generated report may allow the user to navigate to, i.e., select between, different drilldowns for generating a specific report. Thus, the PSED 124 may correspond to a current navigational state in the report.

The DRMS generates reports for display on at least one access device (AD) 130, such as a personal computer that can communicate with the DRMS over any type of network. The AD may include a program 132 that manages the AD-DRMS communications and that produces various visual displays for the user. For example, the program 132 may be created as a client program for the DRMS or may be a conventional browser program, such as Microsoft Internet Explorer. Here, the DRMS provides an output 140 that causes a visual display on the AD of the generated report; i.e., PSED 134 is displayed by the program 132.

Upon reviewing the PSED 134, the user may be interested in accessing the operational data that was used in generating the report. To facilitate such user navigation to the DSS, the DRMS may provide, in connection with generating the visual display for the AD, a navigation link for accessing the PSED 114 stored in the DSS. Upon user selection of the navigation link, the AD generates a user input indicating a request for access to the PSED 114. The user input may include information identifying the particular PSED 134 that is the origin of the user's navigation. The user input is indicated by arrow 150 and is received at the DRMS.

In response to receiving the user input, the DRMS provides information to the AD as indicated by the arrow 160. For example, DSS data can sometimes be accessed based on knowing the identity of the PSED in the DSS, and the identity of the application program that handles it. In such exemplary embodiments, the information 160 may identify the data source 112 and the PSED 114.

The information 160 causes the AD to guide user navigation to the operational data in the DSS. Here, the user navigation is schematically indicated by arrow 170 from the AD to the DSS. Thus, the system 100 provides that a user can navigate from displayed data to operational data on which the displayed data is based.

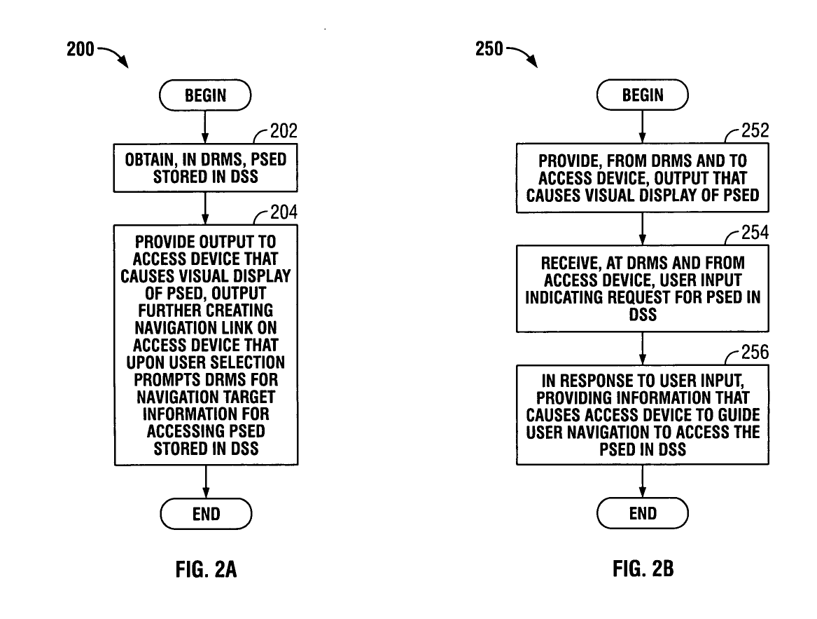

FIGS. 2A and 2B are embodiments of respective inventive methods 200 and 250. The methods 200 and 250 may be performed in the system 100. For example, a computer program product may include instructions that cause a processor to perform operations comprising the steps of any or both of the methods. As shown in FIG. 2A, the method 200 includes the following steps:

Obtaining, in step 202 and in the DRMS, a PSED stored in the DSS. For example, the DRMS may obtain the PSED by replication of the PSED 114 stored in the DSS, as indicated by the arrow 122. Any other way of obtaining the PSED may be used.

Providing, in step 204, an output to the AD that causes a visual display of the PSED, the output further creating a navigation link on the AD that upon user selection prompts the DRMS for navigation target information for accessing the PSED stored in the DSS. For example, the DRMS may provide the output 140 for displaying the PSED 134 on the AD, and the output 140 may further create a navigation link on the AD that the user can select to have the user input 150 sent from the AD to the DRMS.

As shown in FIG. 2B, the method 250 includes the following steps:

Providing, in step 252 and from the DRMS and to the AD, an output that causes a visual display of the PSED. For example, the DRMS may provide the output 140 that causes the PSED 134 to be displayed on the AD.

Receiving, in step 254, at the DRMS and from the AD, a user input indicating a request for access to the PSED in the DSS. For example, user selection of a navigation link may cause the user input 150 to be sent from the AD and received at the DRMS. The user input 150 may indicate that the user requests access to the PSED stored in the DSS.

Providing to the AD, in step 256 and in response to receiving the user input, information causing the AD to guide user navigation to access the PSED stored in the DSS. For example, in response to the user input 150, the DRMS may provide the information 160, which causes the AD to guide the user navigation 170 to access the PSED stored in the DSS.

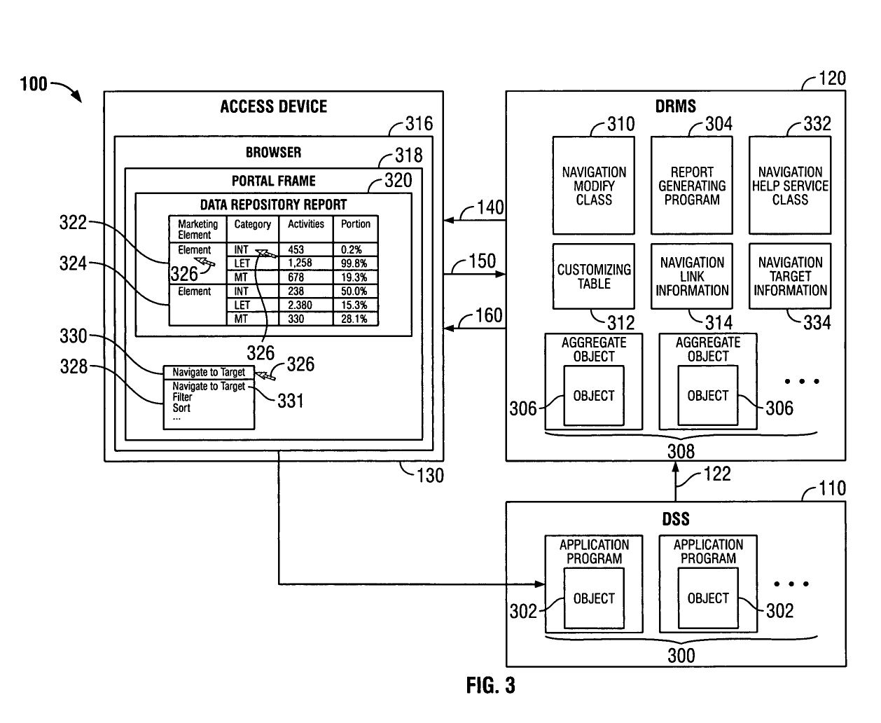

FIG. 3 is another block diagram with examples of features that can be included in the system 100. Here, the DSS includes one or more application programs 300. Each program 300 is capable of handling some or all of the operational data that is processed in the DSS. For example, one or more of the programs 300 may handle CRM functionality such as campaign management, or may handle sales figures for the organization. In this example, the PSED is included in one or more object(s) 302. The PSED may comprise the entire object 302 or a portion thereof. Accordingly, the user navigation will result in the user accessing at least one of the objects 302 to review the PSED. Typically, a unique object key is associated with each of the objects 302 in the DSS. The DSS object key is an identifier by which the object 302 can be accessed in the DSS.

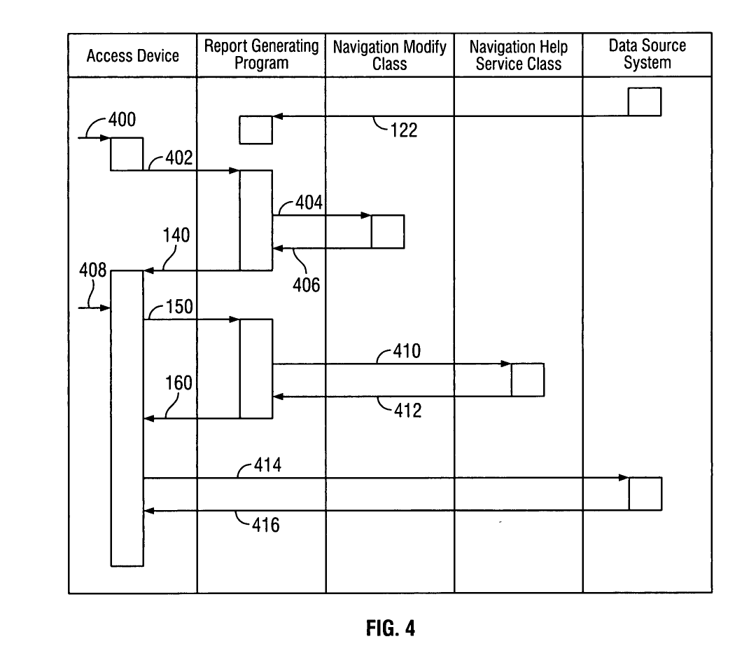

An exemplary operation of the system 100 shown in FIG. 3 will be described with reference also to the sequence diagram shown in FIG. 4. The operation may begin with the replication 122 of source data from the DSS. A report-generating program (RGP) 304 in the DRMS registers that the PSED has been replicated. The replication 122 may be initiated by the DRMS or the DSS and may be performed periodically, sporadically, or upon the occurrence of a predetermined event.

Here, the DRMS stores the PSED in one or more objects 306. The objects 306 may be used when the RGP generates a report. That is, the RGP may extract the PSED from the object(s) 306 and provide it to the AD for display to the user. Similarly to the DSS, the DRMS may associate an object key with each of the objects 306. The DRMS object keys are, however, almost always different from the DSS object keys used for the same operational data. One reason for this may be that the DRMS object keys are given names that are meaningful to non-expert users, while the DSS object keys are mainly used by programmers and developers working with the backend of the system 100.

The DSS object key may be stored in an attribute of the object 302. Upon replication, the DSS object key may be stored in an attribute of the object 306. In some implementations, at least one object 306 is included in one or more aggregate objects 308. That is, the RGP may generate the aggregate object(s) 308 by aggregating several objects 306 (only one object 306 shown in each aggregate object 308 for clarity). In such implementations, the attribute where the DSS object key is stored may be associated with the aggregate object. Thus, the DSS object key may be retrieved by knowing the attribute name and the DRMS object key for the object 306, or by also knowing the DRMS object key for the aggregate object 308.

In other implementations, the DSS object key can be calculated using rules specific to the DSS application program. That is, one or more of the application programs 300 may have an algorithm for calculating the proper DSS object key for any given object. Using that algorithm, the DRMS can determine the proper DSS object key for any of the objects 302. This may be accomplished by providing a so-called customer exit from the standard procedures that would otherwise be performed. For example, a customer exit can be created using the Business Add-In (BAdI) technology developed by SAP AG. Accordingly, the NHSC may perform a mapping from the DRMS object key to the DSS object key. The NHSC furnishes the retrieved information to the RGP as indicated by the arrow 412.

Optionally, the application-specific key determination can be done upon the DRMS obtaining the object(s) 306 from the DSS, wherein the DSS may store the DSS object key such that it can be found if later needed. For example, the DRMS can store the determined DSS object key in an attribute of the object 306, or in an attribute associated with one of the aggregate objects 308. The retrieval and use of object key(s) will be further described below.

At some arbitrary time, the user may make an input to trigger the display of a report on the AD, as indicated by the arrow 400. For example, the user calls for a new report to be displayed. This may cause an input to be made from the AD to the DRMS, as indicated by the arrow 402. At the DRMS, the RGP detects that the DRMS should render the report for display, and therefore sets out to determine whether user navigation from any of the PSED displayed in the report to the corresponding operational DSS data is supported.

To provide a new report for display (or to refresh a previously displayed report), the DRMS should render an output that the AD can use to display the report. The RGP calls a navigation modify class (NMC) 310 on the DRMS, as indicated by arrow 404, to determine whether navigation to operational data should be supported for any or all of the objects 306. The NMC may refer to a customizing table (CT) 312 on the DRMS. An entry in the CT for a given object means that user navigation to the corresponding operational data is supported. Upon finding an entry, then, the NMC causes the report to be modified such that a navigation link is provided for the relevant object.

Entries in the CT contain the relevant information for creating a navigation link to particular operational data. In some implementations, DSS data can be accessed by knowing the name of the backend application that handles it. Thus, the NMC may retrieve the backend application name, i.e., the name of the application 300, for use in creating a navigation link. This constitutes navigation link information (NLI) 314. Optionally, the NLI may also include a user-understandable character string for the navigation link. The NMC may retrieve such a string from the CT or from a separate text table (not shown). The NMC returns the NLI to the RGP, as indicated by arrow 406. The RGP, in turn, compiles the information that makes up the report, including the NLI for any or all of the objects 306, and the DRMS then makes the output 140 to the AD where the rendered report is to be displayed.

The program 132 on the AD may include a browser application 316. Accordingly, the output from the DRMS may be provided in a browser-readable format, such as in Hyper Text Language Markup (HTML) code. In some implementations, the program 132 includes portal technology. For example, one or more portal frames 318 may be displayed in the browser 316, and may support navigation between screens, special functions, and other features.

Here, the DRMS output provides a data repository report 320 that is displayed in the portal frame 318. The report 320 includes a header section with headings “Marketing Element,” “Category,” Activities” and “Portion,” respectively. For example, the report 320 relates to a marketing campaign created in a CRM application. Several items are listed in table format below the header section. Particularly, a first element 322 and a second element 324 are different instances of the object corresponding to the “Marketing Element” heading. Each of the elements 322 and 324 are further broken down by “Category” (under the heading with that name), and the last two columns of the report contain particular numbers and values for the respective categories of the two elements.

The AD will use the NLI included in the output to create one or more navigation links for the displayed report. Navigation links may provide that the user can navigate to the source data for one or more of the elements 322 and 324. In some implementations, such a navigation link is added to a context menu for the displayed object. Context menus may appear on the screen when a user clicks the right mouse button. That is, when the DRMS makes the output 140 to the AD, the NLI included therein may be used in creating a context menu link for navigating to the corresponding source data. This may be facilitated by executable code residing on the AD, such as a JavaScript program. For example, the JavaScript program may detect that the output 140 includes the NLI and use the NLI to create a navigation link in the context menu. Different objects, such as the objects corresponding to the elements 322 and 324, may have different context menus and, if navigation is supported, a proper navigation link should be placed in each of the context menus.

The user can initiate navigation by placing a pointer 326 on an object for which navigation is supported and clicking the right mouse button. For illustration, the pointer 326 in FIG. 3 is placed on instances of the “Marketing Element” and “Category” objects. Upon the user clicking the right mouse button, a context menu 328 appears in the browser 316. If navigation to source data is supported for the selected object, the context menu includes at least one navigation link 330. The text for the navigation link, “Navigate to Target” in this example, may have been retrieved from a text table by the NMC as described above.

The exemplary context menu 328 also includes another navigation link 331 that can be used to navigate to DSS data. For example, it may be possible to access the selected object using either of two different DSS applications. The menu 328 also may include other links, such as “Filter” etc., that are not the focus of this description. In other embodiments, the navigation link may be a user-selectable button, icon, or any other suitable link.

User selection of the navigation link 330 is indicated by arrow 408 in FIG. 4 and may be done using the pointer 326 or a computer keyboard. The selection triggers the user input 150 to be sent from the AD. For example, the user input includes the DRMS object key for the selected object and the DSS application name that the NMC included in the NLI.

The DRMS receives the user input and calls a navigation help service class (NHSC) 332 to determine the proper navigation target, as indicated by the arrow 410. The NHSC may access the CT 312 to determine the DSS object key for the selected object. For example, the RGP may pass the object's DRMS key and the DSS application name to the NHSC. The NHSC, in turn, may use the received information in determining the name of the attribute where the DSS object key is stored. In embodiments where the selected object is included in an aggregate object 308, the NHSC may determine the name of such an object so that the DSS key can be obtained from an attribute of that object. In some implementations, there are DSS application rules for calculating the DSS key, and the NHSC may perform such a calculation. That is, the application may provide an executable instruction that when executed produces the DSS object key.

In response to receiving the user input from the AD, then, the DRMS provides to the AD navigation target information (NTI) 334 as indicated by the arrow 160. The NTI causes the AD to guide user navigation to access the PSED in the DSS. The AD may have executable instructions, optionally included in the above-mentioned JavaScript function, that upon receiving the NTI redirect the browser 316 to the desired DSS application and object. For example, the AD can pass to the browser a specific Uniform Resource Locator (URL) that includes the NTI. When there is a portal application being executed, guiding the user navigation may involve determining the parent portal frame, here the portal frame 318, and submitting the NTI to a navigation method associated with that parent frame.

The browser requests the relevant page from the DSS as indicated by the arrow 414. For example, the request 414 may be a request for information available at a specific URL. The DSS, in turn, responds to the request 414 as indicated by the arrow 416, for example by rendering the requested page to the AD. Thus, the system 100 may allow user navigation from displayed data, through user selection of a navigation link in a report received from the DRMS, to operational data in the DSS from which the DRMS obtained the displayed data.

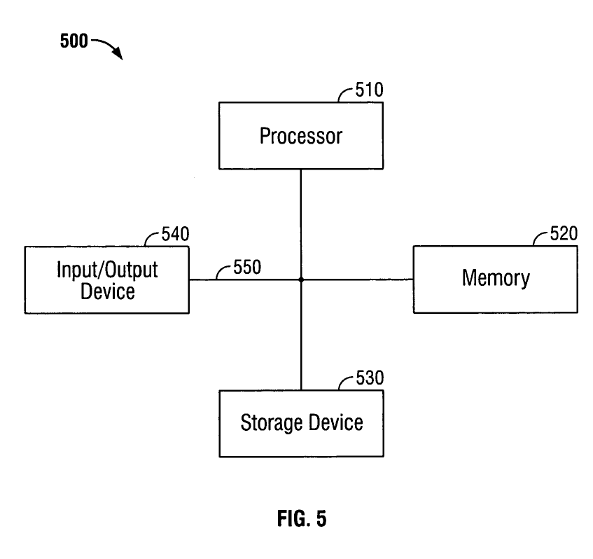

FIG. 5 is a block diagram of a computer system 500 that can be used in the operations described above, according to one embodiment. For example, the system 500 may be included in any or all of the DSS 110, DRMS 120 and AD 130.

The system 500 includes a processor 510, a memory 520, a storage device 530 and an input/output device 540. Each of the components 510, 520, 530 and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of providing user navigation to electronic data stored in a data source system, the method comprising:
providing, from a data repository management system and to an access device, an output that causes a visual display of pre-selected electronic data on the access device, the pre-selected electronic data having been obtained by the data repository management system from a data source system;
receiving, at the data repository management system and from the access device, a user input indicating a request for access to the pre-selected electronic data in the data source system; and
in response to receiving the user input, providing, to the access device, information causing the access device to guide user navigation to access the pre-selected electronic data stored in the data source system.

2. The method of claim 1, wherein the pre-selected electronic data is associated with a first key in the data source system and with a second key in the data repository management system, wherein the user input includes the second key, and wherein the second key is used in determining the first key in the data repository management system for providing the information.

3. The method of claim 2, wherein the data repository management system includes a table that can be used for determining the first key.

4. The method of claim 3, wherein the pre-selected electronic data is included in an object and wherein determining the first key comprises accessing an attribute of the object where the first key is stored.

5. The method of claim 4, wherein the object is included in an aggregate object, and wherein the first key is associated with the aggregate object.

6. The method of claim 3, further comprising overriding a determination of the first key with an action specified by an application in the data source system.

7. The method of claim 2, further comprising determining the first key using rules specified in the data source system.

8. The method of claim 7, wherein the determination is done upon the data repository management system obtaining the pre-selected electronic data from the data source system.

9. The method of claim 1, further comprising, upon the data repository management system obtaining the pre-selected electronic data from the data source system, determining whether the pre-selected electronic data is specified to have at least one navigation target.

10. The method of claim 9, wherein the determination comprises determining whether a table includes an entry for the pre-selected electronic data.

11. The method of claim 10, further comprising retrieving from the table a name of the at least one navigation target from the table.

12. The method of claim 10, further comprising retrieving from the table a character string to be used in presenting a navigation link to the navigation target.

13. The method of claim 1, further comprising receiving navigation target information at the access device and using the navigation target information to create a navigation link from the pre-selected electronic data to at least one navigation target in the data source system, wherein the user input is generated upon user selection of the navigation link.

14. The method of claim 13, further comprising creating the navigation link as a context menu link at the access device.

15. The method of claim 13, wherein multiple application programs in the data source system are navigation targets for the pre-selected electronic data, further comprising creating multiple navigation links to the multiple application programs.

16. The method of claim 13, further comprising retrieving the navigation target information upon the user selection, wherein the user input comprises the navigation target information being transmitted to the data repository management system.

17. The method of claim 16, further comprising receiving the navigation target information at the data repository management system and identifying a table entry for the at least one navigation target.

18. The method of claim 17, wherein the information is provided to the access device based on the identified table entry.

19. The method of claim 18, wherein the identified table entry is used to determine a first key with which the pre-selected electronic data is associated in the data source system, and wherein the information includes the first key.

20. The method of claim 1, further comprising receiving the information at the access device and using the information to guide the user navigation to access the pre-selected information in the data source system.

21. The method of claim 20, wherein the visual display of the pre-selected electronic data is presented in a portal application on the access device.

22. The method of claim 21, wherein guiding the user navigation comprises determining a parent portal frame and submitting the information to a navigation method associated with the parent portal frame.

23. A computer program product tangibly embodied in an information carrier, the computer program product including instructions that, when executed, cause a processor to perform operations comprising
provide, from a data repository management system and to an access device, an output that causes a visual display of pre-selected electronic data on the access device, the pre-selected electronic data having been obtained by the data repository management system from a data source system;
receive, at the data repository management system and from the access device, a user input indicating a request for access to the pre-selected electronic data in the data source system; and
in response to receiving the user input, provide, to the access device, information causing the access device to guide user navigation to access the pre-selected electronic data stored in the data source system.

24. A method of providing user navigation to electronic data stored in a data source system, the method comprising:
obtaining, in a data repository management system, pre-selected electronic data stored in a data source system; and
providing an output to an access device to cause a visual display of the pre-selected electronic data on the access device, the output further creating on the access device a navigation link that upon user selection prompts the data repository management system for navigation target information for accessing the pre-selected electronic data stored in the data source system.

25. A computer program product tangibly embodied in an information carrier, the computer program product including instructions that, when executed, cause a processor to perform operations comprising
obtain, in a data repository management system, pre-selected electronic data stored in a data source system; and
provide an output to an access device to cause a visual display of the pre-selected electronic data on the access device, the output further creating on the access device a navigation link that upon user selection prompts the data repository management system for navigation target information for accessing the pre-selected electronic data stored in the data source system.
